(19) United States
(12) Patent Application Publication
(10) Pub. No.: US 2011/0023522 A1
(43) Pub. Date: Feb. 3, 2011

(54) Evaporator for a drum type ice making machine and method for manufacturing the evaporator

(75) Inventors: Atsushi Sugita, Aichi (JP); Yoshiaki Kumakiri, Aichi (JP); Akihiko Hirano, Aichi (JP)

Correspondence Address: WENDEROTH, LIND & PONACK, L.L.P., 1030 15th Street, N.W.,, Suite 400 East, Washington, DC, 20005-1503, US

(73) Assignee: Hoshizaki Denki Kabushiki Kaisha

(21) Appl. No.: 12/461,054

(22) Filed: Jul. 30, 2009

(51) Int. Cl. F25C 1/10; B23P 15/26; F25B 39/02

(52) U.S. Cl. 62/346; 29/890.045; 62/515

(57) ABSTRACT

An evaporator includes a cylindrical aluminum pipe, and two aluminum flanges which are fixed to both end surfaces of the aluminum pipe by screws. Screw holes into which screws are inserted can be formed in the wall of the aluminum pipe in a direction of the axis of the aluminum pipe simultaneously upon extrusion of the aluminum pipe. Communicating holes formed in the flanges communicate each set of two adjacent through holes among a plurality of the through holes formed in the wall of the aluminum pipe, thereby constructing one continuous coolant flow path inside the evaporator.

### BACKGROUND OF THE INVENTION

1. Field of the Invention

The present invention relates to an evaporator for a drum type ice making machine and a method for manufacturing the evaporator.

2. Description of the Related Art

Japanese Patent Application Laid-open No. 08-29032, for example, describes a conventional drum type ice making machine. In the drum type ice making machine, by rotating a cylindrical evaporator in which a coolant flows and immersing a part of a lower side of the evaporator into ice making water within an ice making tank, ice is produced on an outer peripheral surface (ice making surface) of the evaporator and the ice is peeled from the surface by applying a shearing force with a cutter to obtain ice pieces. An evaporator which is used in such a drum type ice making machine has such a structure that a resin cylinder having a peripheral surface having grooves formed thereon is inserted into an aluminum pipe to form a coolant flow path therein.

However, in order to prevent the evaporator from being shaved due to contact of the ice making surface with the cutter, and in order not to affect the peeling property of the ice, very strict precision is required for dimensions of the evaporator. For that reason, there are problems such as the respective parts of the evaporator being expensive, and careful handling of the parts being required at the time of installation and transportation of the parts.

### SUMMARY OF THE INVENTION

The present invention has been made to solve such problems described above. It is an object of the present invention to provide an evaporator for a drum type ice making machine, which is simplified in its structure and manufacturing process, and a method for manufacturing the evaporator.

An evaporator for a drum type ice making machine according to the present invention comprises:

an aluminum pipe extruded so as to have a cylindrical shape, the aluminum pipe being provided with a plurality of through holes formed in the wall of the aluminum pipe in an axial direction thereof, and

two flanges being provided with communicating holes,

wherein the two flanges are fixed to both end surfaces of the aluminum pipe respectively, said communicating holes communicating each set of two adjacent through holes in the aluminum pipe, each flange being adjusted to construct a coolant flow path in which the plurality of through holes and the communicating holes are continuous.

A method for manufacturing an evaporator of a drum type ice making machine according to the present invention comprises:

extruding a cylindrical aluminum pipe so as to have a plurality of through holes formed in the wall of the aluminum pipe in an axial direction thereof,

preparing two flanges each having communicating holes communicating each set of two adjacent through holes in the aluminum pipe; and

fixing the two flanges to both end surfaces of the aluminum pipe, respectively.

### BRIEF DESCRIPTION OF THE DRAWINGS

In the accompanying drawings:

FIG. 1 shows a perspective view of an ice making section of a drum type ice making machine according to Embodiment 1 of the present invention, a lid being removed from the ice making section;

FIG. 2 shows a cross-sectional view of an evaporator for a drum type ice making machine according to Embodiment 1 of the present invention;

FIG. 3 shows a perspective view of an aluminum pipe of an evaporator for a drum type ice making machine according to Embodiment 1 of the present invention;

FIG. 4 shows an inside of an ice making tank of the ice making section of the drum type ice making machine according to Embodiment 1 of the present invention;

FIG. 5 shows a perspective view of an aluminum pipe of an evaporator for a drum type ice making machine according to Embodiment 2 of the present invention;

FIG. 6 shows a cross-sectional view of an evaporator for a drum type ice making machine according to Embodiment 3 of the present invention;

FIG. 7 shows a cross-sectional view of an evaporator for a drum type ice making machine according to Embodiment 4 of the present invention; and

FIGS. 8A and 8B show partial cross-sectional views of the aluminum pipes of the evaporators for a drum type ice making machines according to Embodiments 1 to 4 of the present invention.

### DESCRIPTION OF THE PREFERRED EMBODIMENTS

Hereinafter, embodiments of the present invention are described with reference to the accompanying drawings.

### Embodiment 1

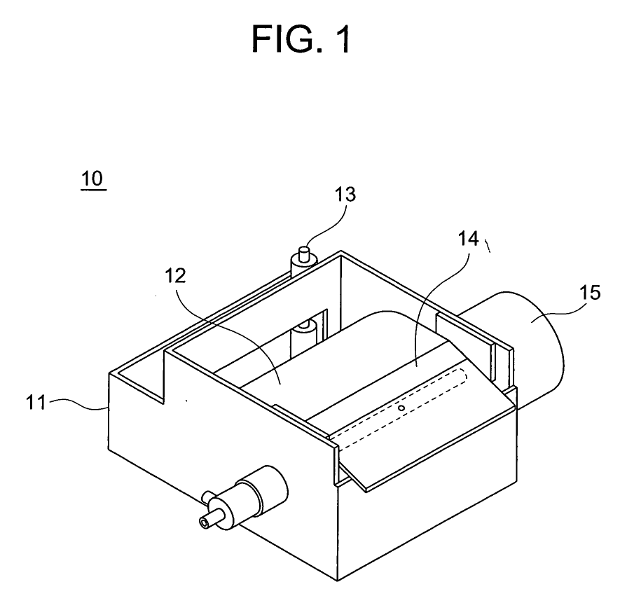

FIG. 1 shows a perspective view of an ice making section of a drum type ice making machine according to Embodiment 1 of the present invention, a lid being removed from the ice making section. An ice making section 10 of the drum type ice making machine includes an ice making tank 11 storing a predetermined amount of ice making water, and a cylindrical evaporator 12 which is provided so at to be rotatable inside the ice making tank 11 while a part thereof is immersed into the ice making water. Inside the ice making tank 11, a float switch 13 for keeping the ice making water supplied from an outside faucet and so on at the predetermined amount, and a cutter 14 which is provided above a water surface of the ice making water so that its edge is directed to an outer peripheral surface (ice making surface) of the evaporator 12 with an appropriate gap between the surface and the edge are provided. Furthermore, outside the ice making tank 11, a gear motor 15 for rotating the evaporator 12 about an axial direction thereof is provided.

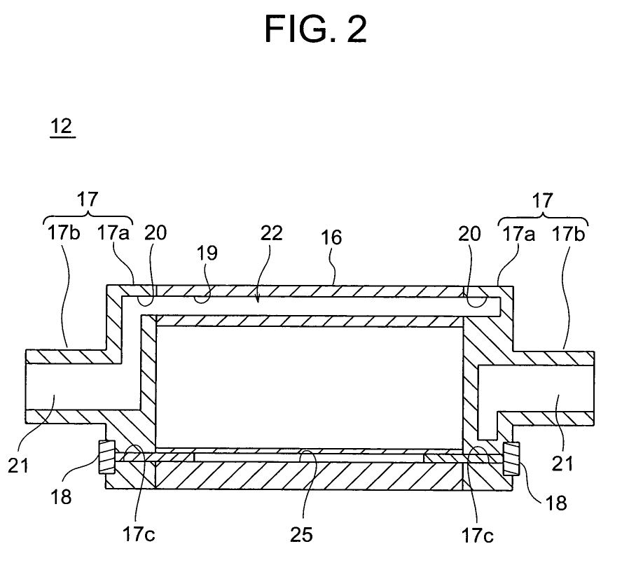

FIG. 2 shows a cross-sectional view of the evaporator 12. The evaporator 12 includes a cylindrical aluminum pipe 16 and two aluminum flanges 17, 17 fixed to both end surfaces of the aluminum pipe 16 with screws 18. Although not illustrated in FIG. 2, gas seals are provided between the aluminum pipe 16 and the flanges 17. In the aluminum pipe 16, as described later, a plurality of through holes 19 (in FIG. 2, only one through hole is illustrated) which are formed in the wall of the aluminum pipe 16 in its axial direction. The flanges 17 include a disk-like main body section 17a and a columnar axial section 17b that extends vertically from a vicinity of the center of one of the surfaces of the main body section 17a with respect to the surface. The flanges 17 are provided with a predetermined numbers of communicating holes 20 at a predetermined location so as to communicate each set of two adjacent through holes 19 when the flanges 17 are fixed to the end surfaces of the aluminum pipe 16. Also, the flanges 17 are provided with a passage 21 which is formed in the axial section 17b from one end thereof to the other end thereof and further communicates to one of the communicating holes 20 inside the main body section 17a. When the two flanges 17, 17 are fixed to both end surfaces of the aluminum pipe 16, the two passages 21, the plurality of communicating holes 20, and the plurality of through holes 19 constitute one continuous coolant flow path 22 communicating from the one passage 21 to the other passage 21 inside the evaporator 12.

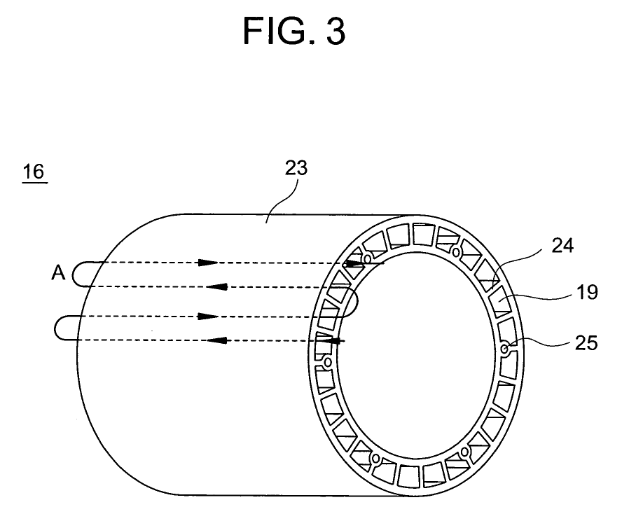

FIG. 3 shows a perspective view of the aluminum pipe 16. The aluminum pipe 16 has a cylindrical shape, and its side wall portion 23 is provided with a plurality of through holes 19 in its axial direction along a circumference thereof. The adjacent through holes 19 are separated from each other by partitioning sections 24. Some of the plurality of partitioning sections 24 are provided with screw holes 25 formed in the wall of the aluminum pipe 16 in its axial direction. That is to say, the screw holes 25 are formed so as to open at both end surfaces of the aluminum pipe 16. As illustrated in FIG. 2, the main body sections 17a of the flanges 17 are provided with screw through holes 17c formed in the main body sections 17a at positions at which the communicating holes 20 and the passages 21 do not intersect and screws 18 that are inserted into the screw through holes 17c and the screw holes 25. In the screw holes 25, female screw grooves are formed to a depth into which at least the screws 18 are inserted to engage with the male threads of the screws 18. With such a structure, fixation of the aluminum pipe 16 and the flanges 17 are enhanced. In FIG. 3, although six screw holes 25 are formed at equal intervals in the circumferential direction thereof, the structure is not limited thereto. The number and positions of the screw holes 25 may be arbitrarily changed in accordance with the size, shape, or the like of the evaporator.

As shown in FIG. 2, if the two flanges 17, 17 are fixed to both end surfaces of the aluminum pipe 16 respectively, the communicating holes 20 formed in the flanges 17 communicate each set of two adjacent through holes 19 to construct one continuous coolant flow path 22. However, as indicated by dashed arrow A in FIG. 3, the respective through holes 19 are communicated in a zigzag manner with respect to the axial direction of the aluminum pipe 16. In other words, when a coolant flows in the coolant flow path 22, adjacent through holes 19 are configured so that the direction of the flow of the coolant is reversed.

Next, an operation of the drum type ice making machine according to Embodiment 1 of the present invention is described.

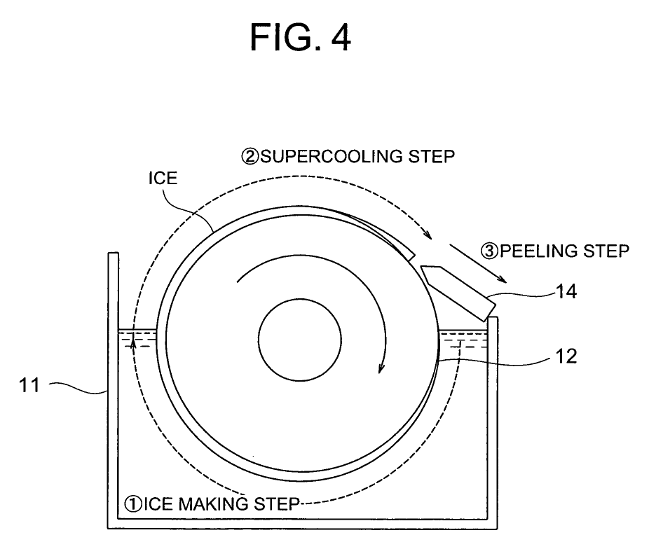

FIG. 4 shows the inside of the ice making tank 11 storing a predetermined amount of ice making water. When the evaporator 12 is rotated by the gear motor 15 (see FIG. 1), the ice making surface is moved into the ice making water (ice making step), moved above the water surface of the ice making water, into a space where there is no ice making water (supercooling step), past the blade of the cutter 14 (peeling step), and again the ice making surface is immersed into the ice making water. The ice making cycle of the drum type ice making machine is composed of the above three steps.

In the ice making step, by performing heat exchange between the ice making water in the ice making tank 11 and the coolant flowing in the coolant flow path 22, ice is produced on the ice making surface and the thickness of the ice increases with the passing of the time. Next, in the supercooling step, by the rotation of the evaporator 12, the ice moved above the ice making water is dried by the heat exchange with the coolant, and is supercooled. Finally, in the peeling step, the ice produced on the ice making surface is peeled by applying a shearing force with the cutter 14 to be ice pieces. When the ice is peeled with the cutter 14, a large torque is applied to the evaporator 12 to cause the evaporator 12 to be distorted. As a result, there is a fear of causing a leakage of the coolant from between the aluminum pipe 16 and the flanges 17 to damage the evaporator 12 or a compressor (not shown) of a refrigeration cycle. However, because the fixation of the aluminum pipe 16 and the flanges 17 is enhanced due to the above-mentioned structure, such damage can be prevented.

Next, a method for manufacturing the evaporator 12 is described.

First, the aluminum pipe 16 is extruded. During this extrusion, not only the through holes 19 but also the screw holes 25 are formed. After the extrusion, the female screw threads are formed from both end portions of the screw holes 25 to at least the insertion depth of the screws 18. Next, the two flanges 17 are manufactured by machine working such as cutting. The respective two flanges 17, 17 sandwich the aluminum pipe 16 from both end surfaces of the aluminum pipe 16. After insertion of the screws 18 into the screw through holes 17c, the screws 18 are inserted into the screw holes 25 to be fixed. In this fashion, the evaporator 12 is completed.

As described above, because the flanges 17, 17 having the communicating holes 20 communicating each set of two adjacent through holes 19, 19 formed in the wall of the aluminum pipe 16 in the axial direction thereof are fixed to both end surfaces of the aluminum pipe 16 to construct the coolant flow path 22 in which a plurality of through holes 19 are continuous, the structure of the evaporator 12 of the drum type ice making machine may be simplified. In addition, because the evaporator 12 is manufactured by extruding the aluminum pipe 16, forming the flanges 17 by the machine working, and fixing the two flanges 17 to both end surfaces of the aluminum pipe 16, the method for manufacturing the evaporator 12 may be simplified.

Furthermore, because the screw holes 25 are formed so as to open at both end surfaces of the aluminum pipe 16 and the flanges 17 are fixed to the end surfaces of the aluminum pipe 16 with the screws 18 such that the screws 18 are inserted into the screw through holes 17c of the flanges 17 and the screw holes 25, the fixation of the flanges 17 and the aluminum pipe 16 may be enhanced. In addition, because the screw holes 25 are formed simultaneously with the extrusion of the aluminum pipe 16, the method for manufacturing the evaporator 12 is prevented from being complicated.

Because the screw through holes 17c are provided at the positions where the communicating holes 20 and the passages 21 do not intersect and the screw holes 25 are provided in the partitioning section 24 between adjacent through holes 19, 19, the screws 18 are not within the coolant flow path 22. Thus, the screws 18 do not block the flow of the coolant, resulting in preventing heat exchanging efficiency from lowering. Furthermore, there is no need to provide a gas seal for preventing the leakage of the coolant at an engagement portion of the screw 18. In addition, because there is no contact between the coolant and the screw 18, any materials of the screw 18 may be freely selected without depending on kinds of the coolant.

### Embodiment 2

Next, an evaporator for a drum type ice making machine according to Embodiment 2 of the present invention and a method for manufacturing the same will be described. In the embodiment described below, because those components identical or similar to those of the Embodiment 1 are denoted by the same reference numerals as in FIGS. 1 to 4 and the detailed descriptions thereof will be omitted.

The evaporator for a drum type ice making machine according to Embodiment 2 of the present invention is obtained by changing the position where the screw hole is formed in Embodiment 1.

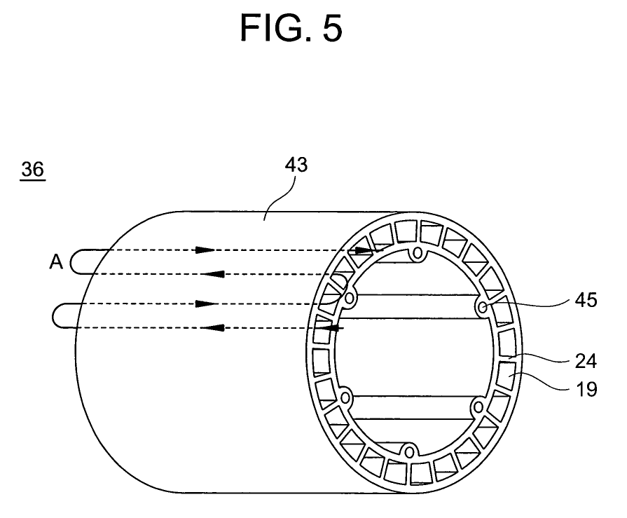

FIG. 5 shows a perspective view of an aluminum pipe 36 of the evaporator for a drum type ice making machine according to Embodiment 2 of the present invention. The inner peripheral surface of a side wall section 43 of the aluminum pipe 36 is provided with screw holes 45 in an axial direction thereof, i.e., so as to open at both end surfaces of the aluminum pipe 36. The other structures are the same as that of Embodiment 1.

As described above, in the evaporator according to Embodiment 2 of the present invention, because the screw holes 45 into which fixing screws are inserted are formed so as to open at both end surfaces of the aluminum pipe 36, the similar effect as one in Embodiment 1 can be obtained. Furthermore, because the screw holes 45 are also formed simultaneously with the formation of the aluminum pipe 36 by the extrusion, there is no increase in the number of manufacturing steps in the method for manufacturing the evaporator.

However, in Embodiment 2, because the screw holes 45 are formed on the inner peripheral surface of the side wall section 43, there is no effect on the sectional area of the through holes 19, that is, on the flow path area of the coolant flow path 22 (refer to FIG. 2). As a result, the flow of the coolant in the through holes 19 is completely unaffected, and the heat exchanging efficiency is not decreased, either. Accordingly, it can be restated that the screw holes 45 can be formed at positions where the screw holes 45 do not affect the flow path area of the coolant flow path 22.

### Embodiment 3

Next, an evaporator for a drum type ice making machine according to Embodiment 3 of the present invention and a method for manufacturing the same will be described.

The evaporator for a drum type ice making machine according to Embodiment 3 of the present invention is obtained by forming screw holes as a separate member and combining the aluminum pipe and the separate member to construct the evaporator in Embodiment 1.

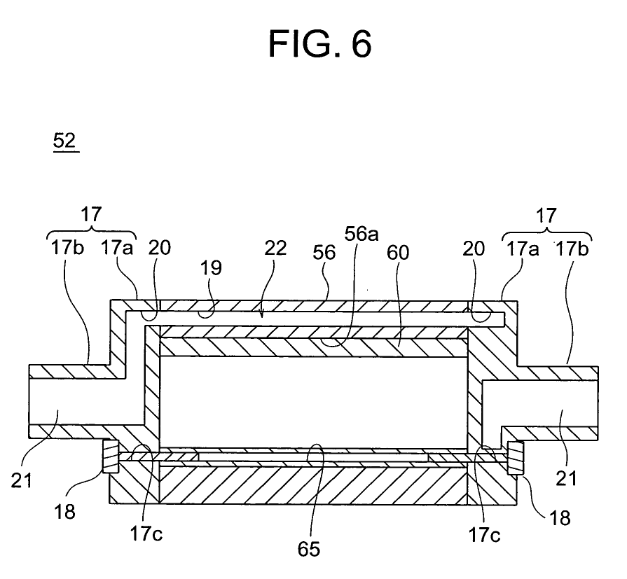

FIG. 6 shows a cross-sectional view of an evaporator 52 for a drum type ice making machine according to Embodiment 3 of the present invention.

The evaporator 52 includes a cylindrical aluminum pipe 56 and two flanges 17, 17 fixed to both end surfaces of the aluminum pipe 56. Although the flanges 17 have the same structure as that of Embodiment 1, the aluminum pipe 56 is different from the aluminum pipe 16 of Embodiment 1 on the point that the screw holes are not formed in the aluminum pipe 56. The aluminum pipe 56 is provided with a cylindrical screw fixing member 60 such that the outer peripheral surface thereof is in contact with an inner peripheral surface 56a of the aluminum pipe 56. That is to say, the screw fixing member 60 is inserted into the aluminum pipe 56. Although not clearly shown in FIG. 6, the length of the screw fixing member 60 in a direction of the axis thereof is slightly shorter than the length of the aluminum pipe 56 in a direction of the axis thereof. In the screw fixing member 60, screw holes 65 into which the screws 18 for fixing the aluminum pipe 56 and the flanges 17 are inserted are formed in a direction of the axis of the screw fixing member 60. That is, the screw holes 65 are formed so as to open at both end surfaces of the aluminum pipe 56 when the screw fixing member 60 is inserted into the aluminum pipe 56. Furthermore, the screw holes 65 have the female screw threads formed from both end portions thereof to at least the depth into which the screws 18 are inserted, as with the screw holes 25 of Embodiment 1.

The fixation between the aluminum pipe 56 and the two flanges 17, 17 is performed by inserting the screws 18 into the screw holes 65 through the through holes 17c such that the respective two flanges 17, 17 sandwich the aluminum pipe 56 from both end surfaces of the aluminum pipe 56 in a state where the screw fixing member 60 is inserted into the aluminum pipe 56. As described above, because the length of the screw fixing member 60 in a direction of the axis thereof is slightly shorter than the length of the aluminum pipe 56 in a direction of the axis thereof, both end portions of the screw fixing members 60 are not in contact with the flanges 17. For that reason, when the screws 18 which are inserted through the through holes 17c into the screw holes 65 and fixed, the two flanges 17, 17 are fixed so as to press the end surfaces of the aluminum pipe 56 toward each other. Thus, the aluminum pipe 56 and the two flanges 17, 17 are fixed such that the aluminum pipe 56 is sandwiched by the two flanges 17, 17.

The other structures of the evaporator 52 are the same as those of the evaporator 12 in Embodiment 1.

The method for manufacturing the evaporator 52 is the same as that in Embodiment 1 except that a resin material such as bakelite or polyethylene, or a metallic material such as stainless steel or an iron-based material is used to form the screw fixing member 60 by extrusion molding so that the screw holes 65 are simultaneously formed, and the two flanges 17, 17 are fixed to both end surfaces of the aluminum pipe 56 in a state where the screw fixing member 60 is inserted into the aluminum pipe 56. As exemplified, the material of the screw fixing member 60 is preferably one having a thermal conductivity lower than that of aluminum.

As described above, in the evaporator 52, the cylindrical screw fixing member 60 having the screw holes formed therein so as to open at both end surfaces is inserted into the aluminum pipe 56, and the two flanges 17, 17 are fixed to both end surfaces of the aluminum pipe 56, respectively, by the screws 18. Accordingly, the same effect as that in Embodiment 1 may be obtained. Furthermore, because the screw holes 65 are formed at the positions where the flow path area of the coolant flow path 22 are not affected, the same effect as that in Embodiment 2 may be obtained. In addition, if a material having low thermal conductivity (for example, the resin materials and metallic materials described above) is used for the screw fixing member 60, dew condensation inside the evaporator 52 may be prevented and improvement of the heat exchanging efficiency of the evaporator 12 may be expected.

Although the screw fixing member 60 is formed into a cylindrical shape, it is not limited to a cylindrical shape. Any shape may be adopted for the screw fixing member 60 as long as the screw fixing member 60 may be inserted into the aluminum pipe 56 and is not unstable when fixing the aluminum pipe 56 and the two flanges 17, 17. Furthermore, although the materials of the screw fixing member 60 are described concretely, they are only examples. Accordingly, in order to attain the above-mentioned object, any materials which those skilled in the art may conceive of can be used. In addition, although the screw fixing member 60 is manufactured here by extrusion, it may also be manufactured by machine working.

### Embodiment 4

Next, an evaporator for a drum type ice making machine according to Embodiment 4 of the present invention and a method for manufacturing the same will be described.

The evaporator for a drum type ice making machine according to Embodiment 4 of the present invention is obtained by fixing the aluminum pipe and two flanges by friction stir welding without the screws in Embodiment 1.

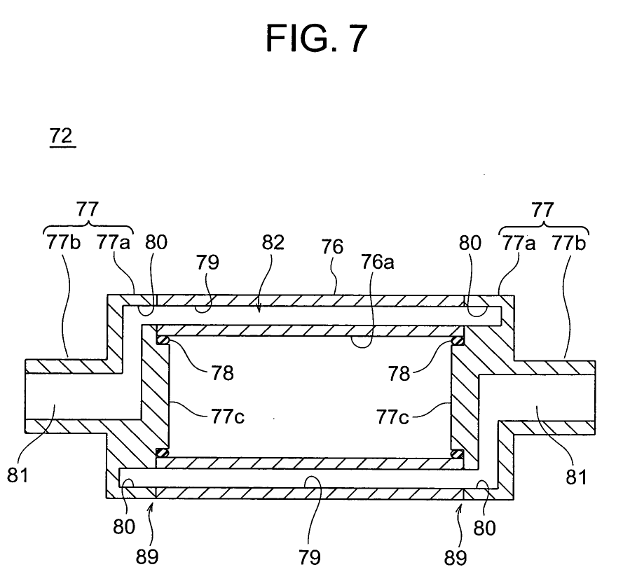

FIG. 7 shows a cross-sectional view of an evaporator 72 for a drum type ice making machine according to Embodiment 4 of the present invention.

The evaporator 72 includes a cylindrical aluminum pipe 76, and two aluminum flanges 77, 77 fixed to both end surfaces of the aluminum pipe 76. The aluminum pipe 76 is provided with a plurality of through holes 79 (only two through holes are shown in FIG. 7) formed in the wall of the aluminum pipe 76 in a direction of the axis thereof. The flange 77 includes a disk-like main body section 77a and an axial portion 77b that extends from a vicinity of the center of one of the surfaces of the main body section 77a perpendicular to the surface. The flange 77 is provided with a predetermined numbers of communicating holes 80 in predetermined positions so as to communicate each set of two adjacent through holes 79 when the flanges 77 are fixed to the end surfaces of the aluminum pipe 76. On the surface of the main body section 77a, which is opposite to the side in which an axis portion 77b is provided, a cylindrical projection section 77c is formed, which is inserted into the aluminum pipe 76 when the flange 77 is fixed to the end surface of the aluminum pipe 76. Between the projection portion 77c and an inner peripheral surface 76a of the aluminum pipe 76, a gas seal 78 is provided. Furthermore, the flange 77 is provided with a passage 81 formed in the axial portion 77b from one end thereof toward the other end thereof and further communicates to one of the communicating holes 80 in the main body portion 77a. When the two flanges 77, 77 are fixed to both end surfaces of the aluminum pipe 76 respectively, the two passages 81, the plurality of communicating holes 80, and the plurality of through holes 79 constitute one continuous coolant flow path 82 communicating from the one passage 81 to the other passage 81. The aluminum pipe 76 and the two flanges 77 and 77 are fixed by friction stir welding (FSW) in the state shown in FIG. 7 along the joining portions 89 between the aluminum pipe 76 and the flanges 77 in the outer peripheral surface of the aluminum pipe 76 and the outer peripheral surface of the main body section 77a.

The method for manufacturing the evaporator 72 is the same as that of Embodiment 1 or 2 except that the fixation of the aluminum pipe 76 and the flange 77 is performed by FSW without any screws and it is unnecessary to form the screw holes when the aluminum pipe 76 is formed by the extrusion. Because FWS is automated, which is different from joining by arc welding, products having a constant quality may be manufactured without depending on the skill of the manufacturer. Furthermore, because FSW may be carried out at a temperature raise of about 80% of the melting point of the material, cracks due to the heat effect are not likely to occur, the lowering of strength is small, and it is difficult for corrosion at thermally influenced sections to generate.

As described above, because the evaporator 72 has a structure in which the aluminum pipe 76 and the flange 77 are fixed to each other by FSW, the same effect as that of Embodiment 1 may be obtained. Furthermore, as no structures that affect the flow path area of the coolant flow path 82 are included, the same effect as that of Embodiment 2 may also be obtained. In addition, because no screws are used for the fixation between the aluminum pipe 76 and the flanges 77, the number of constitutional components may be reduced.

Also, because the method for manufacturing the evaporator 72 is the same as those for Embodiments 1 and 2 except that the fixation of the aluminum pipe 76 and the flanges 77 is carried out by FSW without any screws, the method is simplified compared to the conventional one, similar to Embodiments 1 and 2.

Furthermore, because the aluminum pipe 76 and the flanges 77 are fixed by FSW, no gas seal is needed between the aluminum pipe 76 and the flanges 77 at the joining portions 89. Accordingly, because the outer peripheral surface of the evaporator 72 consists of only aluminum material, cutting and alumite treatment (anti corrosion) may be carried out after the joining of the aluminum pipe 76 and the flanges 77. In this way, as the alumite treatment may be carried out at the final step, axial precision may be improved, so it becomes unnecessary to require high precision in the respective parts, so that costs may be reduced, and careful handling of the parts becomes unnecessary, thereby facilitating their handling.

In addition, no gas seal serving as a heat insulator is provided between the aluminum pipe 76 and the flanges 77. As a result, because not only the outer peripheral surface of the aluminum pipe 76 but also the outer peripheral surface of the main body portion 77a of the flanges 77 may be used as an ice making surface, the ice making performance can be improved and downsizing and lightening can be achieved. Furthermore, because no gas seal is provided between the aluminum pipe 76 and the flanges 77, it is possible to prevent the leakage of the coolant due to deterioration of gas seals, or the like. Although a gas seal 78 is provided between the projection portion 77c and the inner peripheral surface 76a of the aluminum pipe 76, it is isolated from the joining portion 89 and hence it is unaffected by the heat due to FSW. As a result, there is no need to form the gas seal with heat resistance.

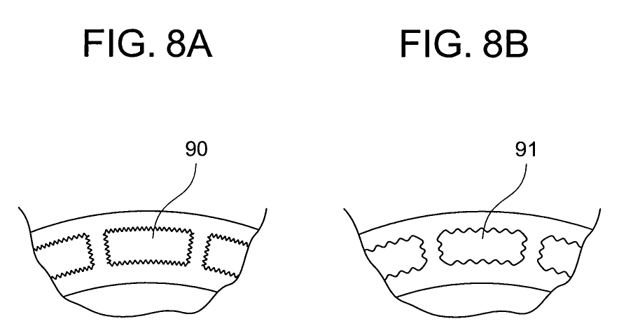

In Embodiments 1 to 4, although the sectional shape of the through holes formed in the aluminum pipe are rectangular, they are not limited to this form but may be formed into any sectional shape. Furthermore, as shown in FIG. 8A, the inner peripheral surfaces of through holes 90 may be formed into a fin shape, and as shown in FIG. 8B, the inner peripheral surfaces of through holes 91 may be formed into a wave shape. In such cases, compared to the case where the inner peripheral surface is flat, because the heat exchanging area is increased, the heat exchanging efficiency can be improved. Also, the through holes 90 and 91 may be formed into such shapes simultaneously with the formation of the aluminum pipe by extrusion. Furthermore, in the case where the aluminum pipe is formed by extrusion, after formation of the through holes having a flat inner peripheral surface, the surface may be processed into the fin shape or the wave shape.

What is claimed is:

1. An evaporator for a drum type ice making machine, comprising:
an aluminum pipe extruded so as to have a cylindrical shape, the aluminum pipe being provided with a plurality of through holes formed in the wall of the aluminum pipe in an axial direction thereof, and
two flanges being provided with communicating holes,
wherein the two flanges are fixed to both end surfaces of the aluminum pipe respectively, said communicating holes communicating each set of two adjacent through holes in the aluminum pipe, each flange being adjusted to construct a coolant flow path in which the plurality of through holes and the communicating holes are continuous.

2. The evaporator for a drum type ice making machine according to claim 1, wherein the aluminum pipe and the flange are fixed with screws and screw holes into which the screws are inserted are formed so as to open at both end surfaces of the aluminum pipe.

3. The evaporator for a drum type ice making machine according to claim 2, wherein the screw holes are formed at a position where the flow path area of the coolant flow is not affected.

4. The evaporator for a drum type ice making machine according to claim 3, comprising a screw fixing member which can be inserted into the aluminum pipe, wherein the screw holes are formed in the screw fixing member.

5. The evaporator for a drum type ice making machine according to claim 1, wherein the aluminum pipe and the flanges are fixed by friction stir welding.

6. A method for manufacturing an evaporator for a drum type ice making machine, comprising:
extruding a cylindrical aluminum pipe so as to have a plurality of through holes formed in the wall of the aluminum pipe in an axial direction thereof;
preparing two flanges each having communicating holes communicating each set of two adjacent through holes in the aluminum pipe; and
fixing the two flanges to both end surfaces of the aluminum pipe, respectively.

7. The method for manufacturing the evaporator for a drum type ice making machine according to claim 6,
wherein the aluminum pipe and the flanges are fixed with screws, and wherein screw holes into which the screws are inserted are simultaneously formed with the formation of the aluminum pipe so as to open at both end surfaces of the aluminum pipe when the aluminum pipe is extruded.

8. The method for manufacturing the evaporator for a drum type ice making machine according to claim 6,
wherein the aluminum pipe and the flange are fixed to each other by friction stir welding.
